(19) United States
(12) Patent Application Publication
(10) Pub. No.: US 2021/0117972 A1
(43) Pub. Date: Apr. 22, 2021

(54) RULE-BASED MESSAGING AND ELECTRONIC COMMUNICATION SYSTEM

(71) Applicant: Capital One Services, LLC, McLean, VA (US)

(72) Inventors: Molly JOHNSON, Alexandria, VA (US); Joshua EDWARDS, Philadelphia, PA (US); Francisco PEREZLEON, Richmond, CA (US); Angelina WU, Vienna, VA (US); Jason JI, Reston, VA (US); Kaitlin NEWMAN, Washington, DC (US); Colin HART, Arlington, VA (US)

(21) Appl. No.: 16/658,413

(22) Filed: Oct. 21, 2019

(51) Int. Cl. G06Q 20/40; G06N 20/00; G06Q 20/22; G06K 9/62

(52) U.S. Cl. CPC G06Q 20/405; G06K 9/6262; G06Q 20/227; G06N 20/00

(57) ABSTRACT

A messaging platform can automatically detect patterns in messaging behavior of a user, and based on the patterns, create and implement rules for incoming messages or other electronic communications. In response to each incoming message or electronic communication, the messaging platform can classify the message or electronic communication based on the created rules. The messaging platform can also perform various tasks in response to receiving the message or electronic communication. For example, the messaging platform can create a calendar entry in the user's calendar, forward a message, archive a message, reply to a message, etc.

### BACKGROUND

In an electronic platform, a message can be a private form of communication between different members of the platform. The message can only be accessed by the users participating in the message. An electronic platform can be a social media platform or a private messaging tool. In social media platforms, personal messaging features can provide a space for private interactions among their users. In private messing tools, users can sign up for accounts and transmit messages to connect privately with selected friends.

### SUMMARY

Electronic messaging is very convenient, reliable and precise. A user can easily draft and transmit a personal message on a social media platform without any cost to the user. When a user transmits the message, the user is confident that the message and its content will be delivered to the recipient. Moreover, the message can be accessible to the sender and recipient for a long time, thereby the sender and the recipient can rely on the message as a record when proof is needed. These features have made electronic messaging very popular, and as a result, electronic messaging has become a crucial mode of communication.

As a result, many individuals receive hundreds, if not thousands, of messages on a daily basis. Organizing these messages can be a daunting task and it takes a long time to read through every message. Additionally, every time a message comes in, the user can be distracted because the message, e.g., pings the user's device. While some of these messages are relevant to the user and might require the user's attention, others might not be as relevant or do not require the user's attention. For example, a message that has been drafted specifically for a particular user, e.g., a friend asking for a time to meet, might be relevant to the user, and the user should review the message and respond to it. On the other hand, a message which sends the user a newsletter might not require the user's attention because the subject matter is not interesting to the user. In fact, the user might have been deleting this type of message every time the user received one. As another example, a monthly reminder to pay a bill might not be useful for a user, particularly when the user sets up automatic payment for certain accounts. It is an object of this disclosure to describe a messaging platform which can automatically detect patterns in messaging behavior of a user, and based on the patterns, create and implement rules for incoming messages or other electronic communications. In response to each incoming message or electronic communication, the messaging platform can classify the message or electronic communication based on the created rules. The messaging platform can also perform various tasks in response to receiving the message or electronic communication. For example, the messaging platform can create a calendar entry in the user's calendar, forward a message, archive a message, reply to a message, etc. This messaging system can offer significant enhancements and improvements to existing messaging systems.

In addition to improving messaging platforms, the messaging system of this disclosure can offer significant improvement to financial transactions' electronic infrastructures because financial transactions share many the characteristics of electronic messaging. Many individuals share expenses with others. For example, some share utility bills with roommates. Each month when a utility bill comes in, one person pays for the bill and that person will have to ask others to reimburse the person for their respective share. In other words, in response to receiving a bill, which can be an electronic bill, the payer transmits an electronic communication to others to receive reimbursement for a part of the bill. This task can be time consuming and in many situations, individuals might avoid asking for reimbursement all together because it is embarrassing to ask for money. Additionally, asking for reimbursement is an unpleasant task because the payer will have to review past transaction data and decide whom to contact for the past payments. It is also an object of this disclosure to describe a rules-based payment platform which recognizes shared transactions and transmits messages which seek reimbursement for these payments.

In one example embodiment, a system is described. The system can include a communication interface that is connected to a network, receives transaction information, and enables the automatic transmission of a shared transaction request based on rule trigger. The system can also include a rules platform that provides, via the network, a user interface that enables a user to establish a rule to generate a rule trigger, wherein the rule specifies that a particular transaction is a shared transaction, the portion of the transaction to be shared, and identification information that identifies an account that is responsible for the shared portion of the transaction. The system can further include memory that stores the rule, the portion of the transaction to be shared, and identification information that identifies an account that is responsible for the shared portion of the transaction. The system can additionally include a streaming data platform that exposes the transaction information to the rules platform such that the rules platform is able to examine the transaction information, determine whether a transaction included in the transaction information is the shared transaction based on the rule, and generate a rule trigger for the shared transaction.

The system also includes an application programming interface that is accessible by the rules platform and, upon a rule trigger, generates a shared transaction request based on the portion of the transaction that is to be shared, and automatically transmits the shared transaction request to an entity associated with the account that is responsible for the shared portion of the transaction. The system can also include a machine learning model that uses at least the transaction information and rule to, for the user, process additional transactions of the user and identify a potential shared transaction based on a correlation between the additional transactions and the shared transaction, present, via the user interface, a request to the user to understand whether the potential shared transaction is a shared transaction, receive, via the user interface feedback from the user, and update the rule based on the user feedback.

### BRIEF DESCRIPTION OF THE DRAWINGS

FIG. 1 shows an example data stream providing data to a server and a client device.

FIG. 2 shows an example user interface for entering rules in a client device.

FIG. 3 shows an example embodiment for training a machine learning model.

FIG. 4 shows an example flow chart displaying the process for requesting a payment.

FIG. 5 shows another example flow chart displaying the process for requesting a payment.

FIG. 6 illustrates exemplary hardware components of a server.

### DETAILED DESCRIPTION

### Collecting the Data

In one example embodiment, the system of the present disclosure can receive data. For example, the data can be a data stream which includes present data (i.e., live data). In another example, the data can be a data batch (i.e., past data collected and stored in a data store). The data can be in the form of a dataset.

In some embodiments, the dataset can include data points relating to incoming and/or outgoing emails from a user's account or device. The data relating to each email can include a sender's email address, at least one recipient's email address, a subject line, a body, a transmission time, and optionally one or more attachments.

In some embodiments, the dataset can include data points relating to other electronic communication items such as calendar entries (or invites), instant messaging communications, name of an application run on a client device, etc. The data relating to each calendar entry can include a sender's email address, at least one recipient's email address, a time for when the entry was made or emailed, a time for the event, a location for the event, and a message. The data relating to each instant messaging communication can include a sender, a recipient, a time for the message, and a body of the message. In one example embodiment, each time a user receives a particular type of message, e.g., weather alert email, the user starts a weather application. In this example embodiment, the dataset can include the name of the application, a time when the application was started, an amount of time the user was using the application, a task performed by the application, etc.

In some embodiments, the dataset can include data points relating to financial transactions, e.g., credit card, debit card, or cryptocurrency transactions. For example, the dataset can include a list of purchases made using a credit card or debit card, wire transfers from a checking account, electronic fund transfer from a cryptocurrency account, a regularly scheduled monthly payment from a checking account, an automatically withdrawn payment, an electronic payment to a friend, etc. For each transaction, the dataset can include information such as a description, a time of transaction, a location for the transaction, an amount or price for the transaction, a name of the merchant or recipient, and optionally a list of the items included in the transaction and the price for each item.

In some embodiments, the dataset can include data points relating to phone records. For example, the dataset can include a list of phone calls made from or received by a particular phone number. Each item on the list can include a phone number for the caller, a phone number for the recipient, a duration of the call, a transcript for the call, a time the call was made, etc.

In some embodiments, the dataset can include data points relating to social media activity. For example, the dataset can include a list of profiles or pages visited by the user in a social media platform, a time for each visit, a duration for the visit and an action taken during or after the visit. The action can be liking a page, sharing a page, commenting on a page, etc.

In one example embodiment, the data included in the dataset can be received in the form of a data stream, e.g., a credit card transaction data stream. For example, for each credit card transaction processed at a processor, the data can be placed on a data stream. The data stream can be provided to various data consumers, e.g., a module of the system of this disclosure. The data consumer can evaluate each data point and apply various logics to the data. For example, a module can evaluate whether one or more rules apply to the incoming data. If so, the module can execute the applicable rules or the module can pass the data to another tool to execute the rule. If the module determines that no rule applies to the data, the module can move to the next transaction. When the module is processing the data in a data stream, the module can keep a pointer where the current transaction is so that if there is a delay between two transactions, the module can determine which transaction needs to be processed next. A data stream does not prevent multiple data consumers from listening simultaneously. As a result, multiple modules can work on a data stream. Each module can have its own pointer, which can determine which transaction was processed last.

In one example embodiment, the data included in the dataset can be received in the form of a data batch. A data batch is past recorded data. A module of a data consumer can process the data batch. The module can query a data store to receive the batch, e.g., a module can ask for all credit card transactions that have happened in the past, e.g., every credit card transaction since the last query.

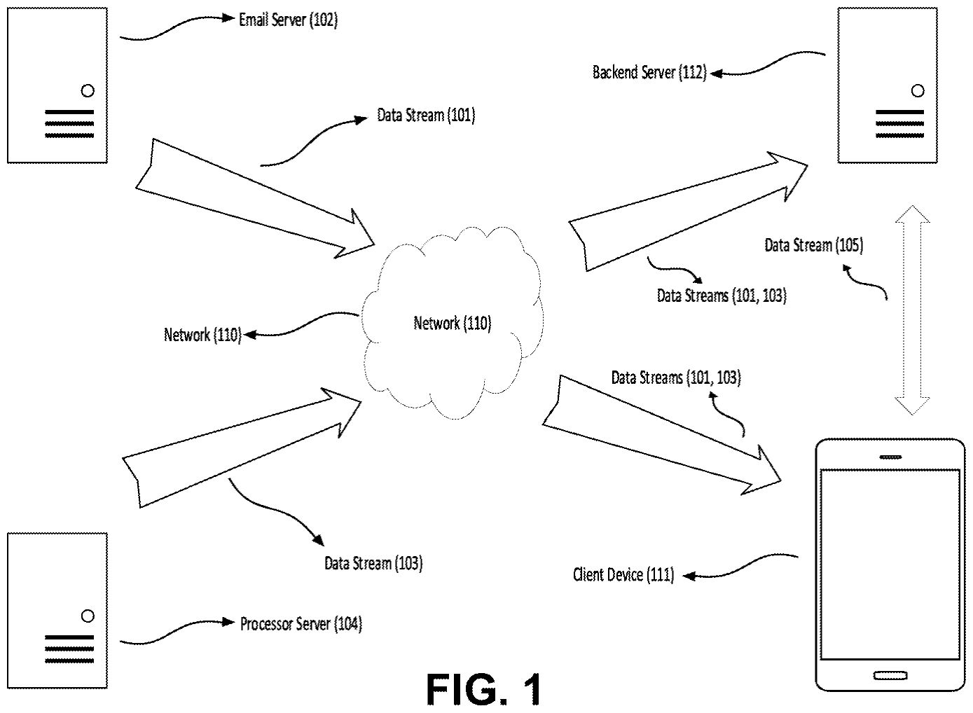

FIG. 1 shows an example data stream providing data to a server and a client device. In this example embodiment, a system 100 can include a data stream 101 and a data stream 103. The data stream 101 can include email data received from an email server 102 and the data stream 103 can include transaction data received from a processor server 104. Each of the data stream 101 and 103 can provide data to a client device 111 and a backend server 112 through a network 110. The client device 111 and/or the backend server 112 can store the data for further analysis. In one embodiment, the client device 111 and/or the backend server 112 can provide the data received from the data stream 101 and 103 to a module for applying various rules to the data.

### Trigger Rules

In one example embodiment, the system can include a user interface for creating rules. The user interface can include various buttons and fields for specifying each rule. For example, for each rule, the user can specify a set of conditions and actions. For each one of the conditions that are met, the system can trigger one or more of the actions.

For example, the user can specify that in response to an incoming email from a utility company including a bill, the system can generate a calendar entry to remind the user about the payment. The rule (or the module which executes the rule) can specifically look for the identity of the sender of the email. If the sender is the same as the utility company, the rule can trigger creation of a calendar entry which includes the body of the email. The date of the calendar entry can match the due date of the bill (or the date of the calendar entry can be calculated based on the due date of the bill such that, e.g., the calendar event can be created one week before the due date of the bill.). As another example, in response to an incoming email from the utility company, the user can require the system to forward the email to the user's friend and include a message such as “please pay for half of the bill.” Specifically, the user can specify the following conditions for the rule: email including the utility company as the sender, the body of the email including the word “bill,” and the email including an attachment. Once these conditions are met, the rule can trigger the creation and transmission of the email.

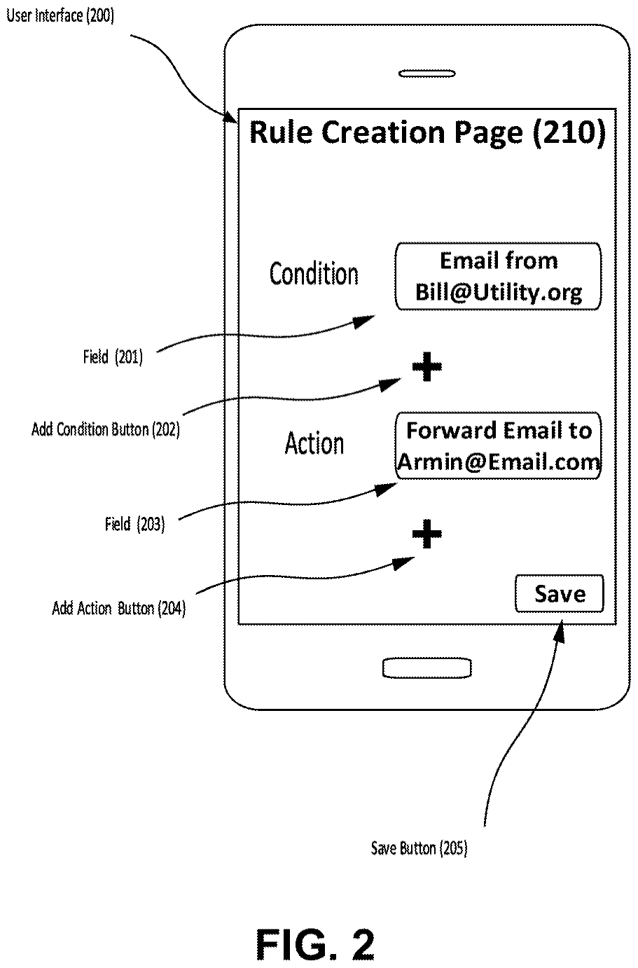

FIG. 2 shows an example user interface for entering rules in a client device. The user interface 200 can include a page 210 for creating the rules. The page 210 can include a field 201 for entering a condition. For example, the condition can require an email from a utility company. The page 210 can also include a field 203 for entering an action. The action can be forwarding the email from the utility company to a friend's email address. Once the condition is satisfied, the client device can execute the action. Page 210 can also include two add buttons, add condition button 202 and add action button 204. By pressing the add buttons, the user can add additional conditions or actions. The page 210 can include a save button 205. When the user has entered all the conditions and actions, the user can press the save button 205 to move back to an application which facilitates the functions of this disclosure.

In one example embodiment, a rule can trigger opening a bank application on a cellphone in response to receiving an email from the bank including the word “alert.” Specifically, if the sender of the email is the bank, and the subject line of the email includes the word “alert,” the rule can trigger the bank application. In one example embodiment, a rule can trigger a bill payment, e.g., set up an online payment, in response to receiving a notification asking the user to pay for the bill (or a phrase implying the same concept). The module executing the rule can look for notifications from applications on a user device. If any of these applications displays a notification which ask for a payment (as determined by a NLP module defined below), the rule can trigger a module which can set up a payment. In one example embodiment, a rule can initiate a payment to another account holder using a cryptocurrency after the user receives an email which was forwarded from the account holder and the email includes the word “bill.” The user can specify the payment amount to be equal to a third of the amount included in the forwarded email. Because the payment amount is in a cryptocurrency, the exchange rate of the cryptocurrency can also impact the amount of the payment at the time of the payment. For example, a module can convert the payment amount to a cryptocurrency amount on the due date and trigger the payment.

### Automated Rule Generation

In one example embodiment, a system can use a machine learning model and a natural language processing (“NLP”) module to generate the rules. The NLP module can analyze various datasets and create data groups including data points that are related to each other. The data groups can be provided to a machine learning model to train the model and make predictions about incoming data.

Natural language processing (NLP) technology is capable of processing and analyzing natural language data, which can involve speech recognition, natural language understanding, and natural language generation. The NLP module can perform tasks associated with processing and analyzing natural language data. For example, the NLP module can include different submodules, such as Natural Language understanding (NLU) submodule, natural language generation (NLG) submodule, and Sentiment Analysis submodule. The NLU submodule can process incoming text and derive meaning from the text. The NLG submodule can take a meaning that is to be communicated and express that meaning in appropriate text. The Sentiment Analysis submodule can determine a polarity and topic of a text that expresses feelings or opinions. In one example embodiment, the NLP module can identify nouns in sentences. The NLP module can also determine human names, city names, company names, etc. These nouns can be stored in a knowledge graph database. The NLP module can also determine relationships between the nouns in a sentence.

In one example, the intent recognition module can analyze a text, e.g., an email, an electronic communication, or a transcript for a call, and determine at least one or more requests discussed in the text. For example, the intent recognition module can use intent classification techniques. Intent classification can be a natural language understanding (“NLU”) task that can understand at a high level what the user's intent is in a text, and thus, what request the user is intending to make in the text. The intent recognition module can determine the intent using hard-coded rules with regular expression (i.e., scanning the words). The intent recognition module can also determine the intent by training a supervised machine learning classification model on labeled data. Many machine-learning models can be used for this purpose, e.g., a neural network (or deep learning), a recurrent neural net such as LSTM, decision tree-based methods like random forest or gradient boosted machines, support vector machine, logistic regression, etc. The intent recognition module can also include some preprocessing modules to convert text into character, word, or sentence embeddings that can be fed into the model. Basic preprocessing can include stemming or lemmatization, sentence or word tokenization, stopword removal, etc. This can include a term frequency based approach, including TF-IDF, or Word2Vec, Universal Sentence Encoder, etc. Part of the NLU can also include dependency parsing to try to capture negation, or sentiment analysis.

In one example embodiment, the NLP module can compare and evaluate data relating to various items included in the dataset, e.g., emails, calendar entries, phone calls, social media activities, and financial transactions. The module can assign some of these items to the same group or groups. For example, the NLP module can assign emails, calendar entries, phone calls, social media activities, and financial transactions that relate to the same words, concepts or subject matters to the same data group or data groups. A supplemental module, e.g., a data aggregator, can also limit the items that can be assigned to each data group based on the time each item was created, received, sent, modified, etc. This time limit can further ensure that only relevant items are assigned to each data group.

In one example, the dataset can include email data which can consist of incoming email data and outgoing email data. The NLP module can analyze the email data and assign certain emails to one or more data groups. Each data group can include one or more emails that are relevant to each other. For example, the NLP module can analyze the first few sentences or all the content of each email. If two emails include similar or the same words, subject matter or concept, or similar words, subject matter or concept, the two emails can be assigned to the same data group. The supplemental module can also assign the emails to a data group based on the time when the emails were transmitted. For example, the emails can be assigned to the same data group only if the time stamps for the emails fall within a period of 10 hours. By assigning relevant emails to the same data groups, the machine learning model can study actions taken (e.g., emails sent) in response to an incoming email. For example, the machine learning model can learn that each time an email is received from a utility company (i.e., incoming email), the email is forwarded to two individuals. Based on this, the machine learning model can generate a rule which forwards emails from a utility company to the two individuals.

In an example embodiment, the dataset can include data relating to emails, calendar entries, phone calls, social media activities, and financial transactions. The NLP module can review this data and assign some or all the items to one or more data groups. By assigning these items to data groups, one can create training data for the machine learning model. Specifically, the machine learning model can learn about a trigger event that occurs first and one or more actions that follow the trigger event. The trigger event can be an email, calendar entry, phone call, social media activity, or financial transaction. The action that follows can be an email, calendar entry, phone call, social media activity, or financial transaction. The machine learning model can be provided with this training data, and using the training data, the machine learning model can generate various rules. For example, the machine learning model can be trained to generate rules which provide that when the trigger event occurs, the action must follow.

In one example, every Tuesday morning, a manager of a company sends a meeting schedule email to a secretary and in response, the secretary schedules a meeting as specified in the email. In this example, the dataset can include all the incoming emails in the secretary's mailbox as well as all the calendar invites that were sent out. The NLP module can review the dataset and analyze whether the items can be assigned to one or more data groups. The NLP module (in association with the supplemental module) can evaluate the items only if they are time stamped within a 24-hour period. As a result of the evaluation, for each week, the NLP can assign the manager's meeting schedule email and the secretary's calendar invite to the same data group. If one assumes that the manager sent 50 meeting schedule emails in one year, the secretary must have sent out 50 calendar invites. Each pair of a meeting schedule email and the corresponding calendar invite is assigned to the same data group, and because the analysis is limited by time (i.e., the 24-hour period), for each week there is one and only one data group. The data groups can be provided to a machine learning model as labeled data to train the model.

In one example embodiment, the NLP module (optionally in association with the supplemental module) can evaluate items involving a financial transaction. For example, the first item (or the trigger event) can be a financial transaction, e.g., a payment at a supermarket, a payment at a restaurant, a payment for a utility bill, etc. The action that follows the trigger event can be an email requesting money, an instant message money request or other action. The NLP module can match the first item and the second item, e.g., based on a description of the financial transaction and a description in the email. In one example embodiment, the supplemental module can be provided which can ascertain a relationship between the financial transaction and the action that follows the financial transaction. For example, the supplemental module can determine that the user requested a payment for half of the utility bill payment. As another example, the supplemental module can determine that the user requested a payment only for certain items in the supermarket bill, e.g., groceries and not toiletries. The NLP module can assign the items to data groups and the supplemental module can provide metadata for each group.

In one example embodiment, prior to analyzing the data using the NLP module, a filtering technique (or sanitation technique) can be used to refine the data included in the dataset or each data group. For example, there are instances in which an item is included in the dataset that if the item is provided to the NLP module, the NLP module might incorrectly classify the data as belonging to a group.

In one example embodiment, data that is susceptible to misclassification can be deleted from the dataset so that the NLP module would not misclassify the data. For example, each month the user can receive a paycheck. After receiving the paycheck, the user can spend the money on various household expenses. However, these expenses can be one-off expenses and they are not reliable training data for the machine learning model. In this example, the paycheck data can be deleted from the dataset.

### Machine Learning Model

Both supervised and unsupervised learning model can be used to generate the rules. In one example embodiment, the data groups can be provided to a machine learning model as training data. Machine learning uses statistical techniques for teaching computers with data to perform specific tasks without being explicitly programmed to do so. The goal of machine learning is to construct algorithms that can learn from and make predictions on data. These algorithms work by creating mathematical models which can classify data. The process of creating the models can involve training and fine-tuning the model parameters using input data.

In some embodiments, multiple datasets are used at different stages of creating the model. These datasets can include a training dataset, a validation dataset, and a test dataset. Initially, the training dataset can be used to fit the parameters of the model. The training dataset can include an input vector and the corresponding answer vector (or the target or label). In this stage, the training dataset is fed to the model, and the model produces a result set, which can be compared with the target. Based on this comparison, the parameters of the model can be adjusted. After adjusting the parameters of the model, a validation dataset can be fed into the model to further refine the parameters of the model. The validation dataset provides an unbiased evaluation of the model fit on the training dataset while tuning the model's hyperparameters. Finally, the test dataset can be used to provide an unbiased evaluation of a final model fit on the training dataset.

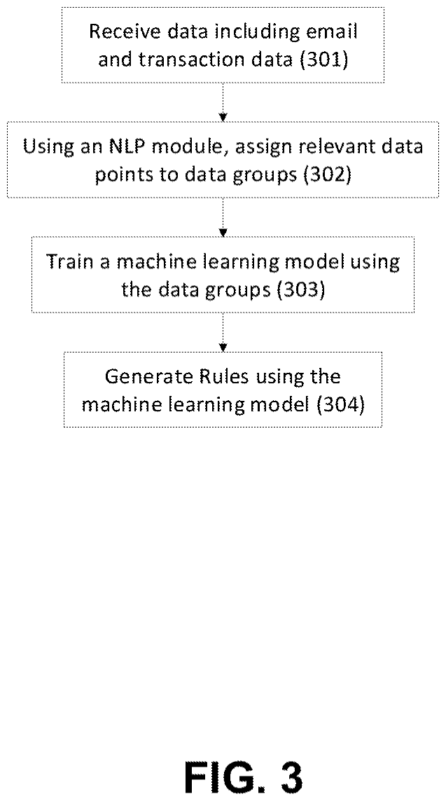

FIG. 3 shows an example embodiment for training a machine learning model. In this example embodiment, in step 301, data in the form of datasets is provided to a NLP module. In step 302, the NLP module assigns various data points to several data groups. In step 303, the data groups can be provided to a machine learning model to train the model. For example, data relating to emails, calendar entries, phone calls, social media activities, and financial transactions can be assigned to various data groups and these data groups can be provided to the machine learning model. In step 304, the machine learning model can use this data to suggest rules.

Once the machine learning model is trained, the model can be provided with live data. For example, in the case of the manager who sends out emails (including a schedule) every week, the model can be trained to generate a rule which can convert the email to a calendar entry (or provide instructions to a module to convert the email to a calendar entry) when an email from the manager is received. Specifically, the model can determine that receiving an email from the manager is a condition, and once this condition is satisfied, a calendar entry must follow. The model can use the condition and the action that followed the condition to generate the rule. As another example, the module can generate a rule that when a payment is made to a restaurant, an email will be send to two individuals asking for paying one third of the bill.

In one example embodiment, all the rules can be provided to a module and the module can apply the rules to incoming data points. For example, if a payment is made at a restaurant, the module can apply the rule to transmit an email and request a payment.

In one example embodiment, a supplemental module can be used to convert instructions provided by the machine learning model to computer code. For example, the machine learning model can be in communication with a model. Each time the model makes a prediction or suggestion, i.e., generates a rule, the model can send the rule to the supplemental. The supplemental module can convert the rule generated by the machine learning model to computer readable instructions and transmit the computer readable instructions to another module for execution.

### The System

In one example embodiment, the machine learning model is located on a backend server, e.g., backend server 112. The backend server can receive data from various sources. For example, the backend server can be connected to a plurality of servers (e.g., email server 102 or processor server 104) and/or the user's device, e.g., client device 111. The backend server can receive email, calendar entry, phone call, social media activity, and financial transaction data from these servers, e.g., data streams 101, 103. As another example, the backend server can receive data from the user's device or provide data to the user's device, e.g., data stream 105. The backend server can use this data to train the machine learning model. The backend server can also use this data to execute the rules with respect to incoming data points. For example, based on past transactions, a machine learning model generated a rule which requires restaurant transactions to be shared, i.e., divided in two and that a friend of the user pay for half of the bill. When a transaction at a restaurant is recorded, the backend server can execute the rule and require the transaction to be shared. If so, the backend server can transmit an email on behalf of the user to request a payment.

As another example, the backend server can trigger an action on the user's device (or the client device). The backend server can send a message to the client device and the message is configured to trigger an action contemplated by an applicable rule. For example, in response to receiving an email about a weather alert, the applicable rule requires initiation of a weather application on the client device. The backend server can be notified about this incoming email, e.g., through a communication with the user's email server. This can trigger the rule. In response, the backend server can transmit a message to the client device. This message can trigger initiation of the weather application on the user's device.

In one example embodiment, the machine learning model and/or the rules can be stored on the client device. The model can either generate or suggest the rules on the client device. The client device can be connected to a plurality of servers and receive data from these servers. In response to receiving incoming data, the machine learning model can generate rules or suggest rules on the client device. Also, in response to receiving incoming data, a module of the client device can execute rule and trigger actions.

In one example embodiment, the machine learning model can suggest rules to the user. For example, after evaluating the user's email data for the past month, the machine learning model can ascertain certain patterns. The machine learning model can generate at least one suggested rule which replicates the pattern. In this example embodiment, the machine learning model can present the rule to the user of the client device, e.g., in a notification. The user can decide whether the user desires to implement the rule. If the user desires to implement the rule, the user can approve the rule. Otherwise, the user can reject the rule. In instances that the user rejects the suggested rule, the machine learning model can prompt a follow-up question. For example, the machine learning model can ask the user if the user rejected the rule because it was incorrect. If the user indicates that the suggested rule was incorrect, the machine learning model can use the user's feedback to update the model, i.e., as a feedback loop.

In one example embodiment, the client device or the backend server can use the rules to make suggestions to the user. For example, a rule can require forwarding an email from a utility company to two individuals. Instead of implementing the rule, the client device can make suggestions using the rule. For example, when the user is drafting an email to forward the message to the utility company, the client device can make a recommendation to use the two individuals' email addresses to forward the email. As another example, when the user pays for dinner at a restaurant, the client device can open an application for sending payment requests. However, the client device does not send the request, but rather wait for the user to approve the request and transmit it.

### Example Embodiment

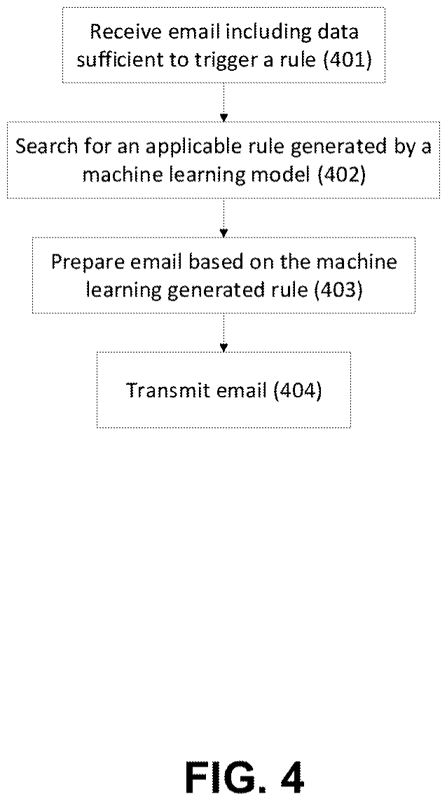

In one example embodiment, two roommates share utility and grocery expenses. For example, the utility expense can include a cable bill and the grocery expense can include a purchase at a supermarket, drug store or similar facility. FIG. 4 shows an example flow chart displaying the process for requesting a payment. In step 401, the user can receive an email indicating that the user needs to pay for a utility bill. The user also pays for a grocery purchase at a supermarket. The client device can receive email data from an email server. The client device can receive the purchase details (including the price and list of items purchased) from a credit card application. The client device can store a plurality of rules generated based on the past email and credit card data. In step 402, the client device can search for an applicable rule. One of these rules can forward the utility bill to the roommate and include the text “please pay.” The client device has asked the user if the user wants to implement this rule, and the user has agreed to implement the rule. Thus, in step 403, upon receiving the utility bill email, the client device automatically prepares an email to the roommate and includes the text “please pay.” In step 404, the client device transmits the email to the roommate.

Another one of these rules can open a payment application and make a suggestion as to how much to request from the roommate. Upon receiving the details from the credit card application, the rule can trigger a module which can cause the payment application to open and display a suggested amount to request. The suggested amount can include half of the grocery expenses but excludes the toiletries.

In one example embodiment, the machine learning model can learn patterns about categories of expenses or purchases and generate rules for these categories of expenses or purchases. For example, the machine learning model can generate a rule which requests payment for every purchase at a drug store (as opposed to a particular drug store) or a dining facility (as opposed to a particular restaurant). As another example, the machine learning model can generate a rule for requesting payment relating to all utility bill payments, e.g., electric, phone and cable. These rules are not tied to a particular merchant or supplier. Rather, they are based on a category of expense or purchase.

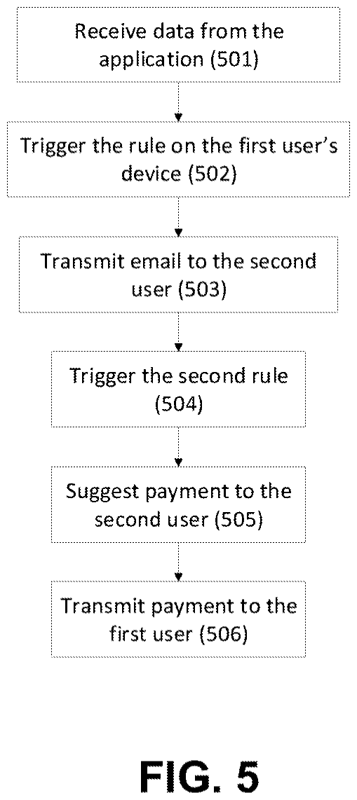

FIG. 5 shows an example flow chart displaying the process for requesting a payment. In this example embodiment, the machine learning model for a first user can set a rule for restaurant payments, e.g., based on past interactions between the first user and the second user. Specifically, the rule can require sending an email to a second user if the first user pays for a restaurant check. The email can ask the second user to pay for half of the check. The rule can be triggered once the charge for the restaurant check appears on the first user's credit card account or transaction list (e.g., as it appears on a credit card software application). The machine learning model for the second user can set a rule for paying the first user. The second rule can be triggered when the second user receives an email from the first user requesting a payment. In response, the second rule can cause an electronic payment application of the second user to open and prompt the second user to make a payment. The rule does not automatically cause making the payment, rather waits for the user to approve the suggested payment.

In this example embodiment, in step 501, a credit card application of the first user displays a restaurant related charge. In step 502, the rule on the first user's device is triggered and in step 503 an email is transmitted to the second user requesting a payment. In step 504, the rule on the second user's device is triggered, and in step 505, a payment application suggesting a payment to the first user is opened on the second user's device. In step 506, upon approval of the second user, the payment is transmitted to the first user.

### Technical Implementation of the Server

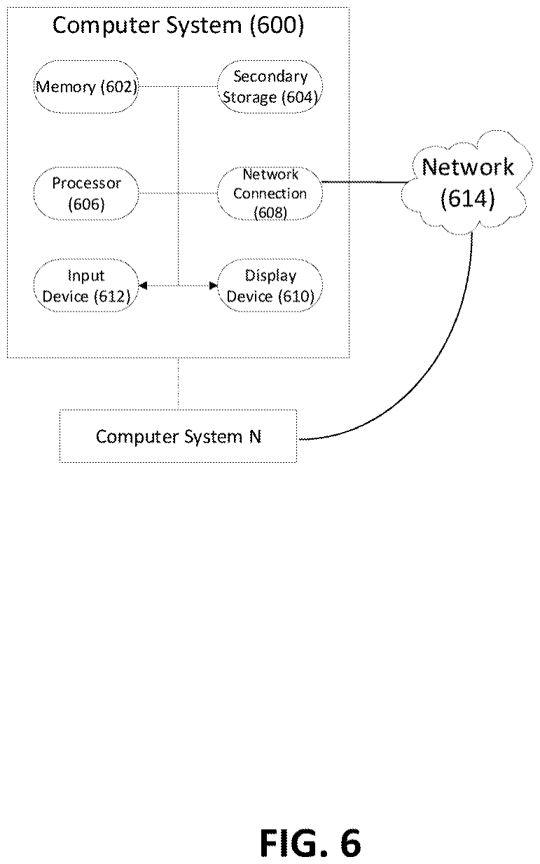

FIG. 6 illustrates exemplary hardware components of a server. A computer system 600, or other computer systems similarly configured, may include and execute one or more subsystem components to perform functions described herein, including the steps of various flow processes described above. Likewise, a mobile device, a cell phone, a smartphone, a laptop, a desktop, a notebook, a tablet, a wearable device, a server, etc., which includes some of the same components of the computer system 600, may run an application (or software) and perform the steps and functionalities described above. Computer system 600 may connect to a network 614, e.g., Internet, or other network, to receive inquiries, obtain data, and transmit information and incentives as described above.

The computer system 600 typically includes a memory 602, a secondary storage device 604, and a processor 606. The computer system 600 may also include a plurality of processors 606 and be configured as a plurality of, e.g., bladed servers, or other known server configurations. The computer system 600 may also include a network connection device 608, a display device 610, and an input device 612.

The memory 602 may include RAM or similar types of memory, and it may store one or more applications for execution by processor 606. Secondary storage device 604 may include a hard disk drive, floppy disk drive, CD-ROM drive, or other types of non-volatile data storage. Processor 606 executes the application(s), such as those described herein, which are stored in memory 602 or secondary storage 604, or received from the Internet or other network 614. The processing by processor 606 may be implemented in software, such as software modules, for execution by computers or other machines. These applications preferably include instructions executable to perform the system and subsystem component functions and methods described above and illustrated in the FIGS. herein. The applications preferably provide graphical user interfaces (GUIs) through which users may view and interact with subsystem components.

The computer system 600 may store one or more database structures in the secondary storage 604, for example, for storing and maintaining the information necessary to perform the above-described functions. Alternatively, such information may be in storage devices separate from these components.

Also, as noted, processor 606 may execute one or more software applications to provide the functions described in this specification, specifically to execute and perform the steps and functions in the process flows described above. Such processes may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the computer system 600.

The input device 612 may include any device for entering information into the computer system 600, such as a touch-screen, keyboard, mouse, cursor-control device, microphone, digital camera, video recorder or camcorder. The input and output device 612 may be used to enter information into GUIs during performance of the methods described above. The display device 610 may include any type of device for presenting visual information such as, for example, a computer monitor or flat-screen display (or mobile device screen). The display device 610 may display the GUIs and/or output from sub-system components (or software).

Examples of the computer system 600 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 600 is shown in detail, system 600 may use multiple computer systems or servers as necessary or desired to support the users and may also use back-up or redundant servers to prevent network downtime in the event of a failure of a particular server. In addition, although computer system 600 is depicted with various components, one skilled in the art will appreciate that the system can contain additional or different components. In addition, although aspects of an implementation consistent with the above are described as being stored in a memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer system 600, to perform a particular method, such as methods described above.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

1-28. (canceled)

29. A system, comprising:
a memory configured to store a plurality of electronic messages and a plurality of rules, wherein:
each electronic message includes at least one attribute;
at least some of the electronic messages are associated with one or more group labels;
each rule is associated with a condition relating to an attribute of an electronic message and a trigger action such that when the condition is satisfied, the rule is configured to cause the trigger action; and
at least one of the plurality of rules is generated using a machine learning model;
a processor configured to generate the at least one rule and analyze an incoming electronic message, wherein:
the processor is configured to execute a machine learning algorithm on data to generate the machine learning model, wherein the data includes the plurality of electronic messages and their respective group labels and attributes; and
the processor is configured to analyze the incoming electronic message by determining whether the at least one attribute of the incoming electronic message matches the condition of one of the plurality of rules, and when the at least one attribute of the incoming electronic message satisfies the condition of one of the plurality of rules, the processor is configured to execute the rule for which the condition is satisfied.

30. The system of claim 29, wherein the at least one attribute is an email address, a subject line, a body, and/or a transmission time.

31. The system of claim 30, wherein the condition for one rule is that if an email address of the incoming electronic message matches a predetermined email address, the processor will forward the incoming electronic message to a plurality of email addresses.

32. The system of claim 29, wherein the data further includes credit card data and calendar entries.

33. The system of claim 29, wherein the at least one attribute includes a shared transaction data.

34. The system of claim 33, wherein the shared transaction data includes a shared transaction amount.

35. The system of claim 34, wherein the processor is configured to:
using the machine learning model, generate a shared transaction rule, wherein in response to receiving the incoming electronic message including the shared transaction amount, the shared transaction rule is configured to cause the processor to transmit a request message to an email address.

36. The system of claim 34, wherein the processor is configured to:
using the machine learning model, generate a shared transaction rule, wherein in response to receiving the incoming electronic message including the shared transaction amount, the shared transaction rule is configured to cause the processor to transmit a notification to a client device.

37. The system of claim 36, wherein the notification is configured to cause the client device to initiate an application.

38. The system of claim 29, wherein the processor is configured to generate a new rule, using the machine learning model, and transmit the new rule to a client device through the transceiver.

39. The system of claim 38, wherein the processor is configured to generate the new rule based on a subset of the data.

40. The system of claim 38, wherein the transceiver is configured to receive a feedback response from the client device.

41. The system of claim 40, wherein the processor is configured to update the machine learning model based on the feedback response.

42. The system of claim 29, wherein the incoming electronic message includes a request for payment.

43. The system of claim 42, wherein the processor is configured to determine whether the incoming electronic message triggers at least one condition of one rule, and if the incoming electronic message triggers at least one condition of one rule, the processor is configured to execute an electronic payment.

44. A method comprising:
receiving and storing in a memory a plurality of electronic messages, wherein each electronic message includes at least one attribute and at least some of the electronic messages are associated with one or more group labels;
generating, using a processor, at least one rule by executing a machine learning model, wherein:
the machine learning model is created using a machine learning algorithm and data including the plurality of electronic messages and their respective group labels and attributes; and
each rule is associated with a condition relating to an attribute of an electronic message and a trigger action such that when the condition is satisfied, the rule is configured to cause the trigger action; and
determining, using the processor, whether the at least one attribute of the incoming electronic message matches the condition of the rule, and when the at least one attribute of the incoming electronic message satisfies the condition of the rule, executing the rule to perform the trigger action.

45. The method of claim 44, further comprising generating, using the processor, a new rule, using the machine learning model, and transmitting the new rule to a client device through the transceiver.

46. The method of claim 45, wherein the processor is configured to generate the new rule based on a subset of the data.

47. The method of claim 46, further comprising receiving a feedback response from the client device.

48. The method of claim 47, further comprising updating the machine learning model based on the feedback response.
